(19) United States
(12) Patent Application Publication
(10) Pub. No.: US 2022/0225679 A1
(43) Pub. Date: Jul. 21, 2022

(54) VAPORIZATION CORE, ELECTRONIC VAPORIZATION DEVICE, AND METHOD FOR MANUFACTURING THE SAME

(71) Applicant: SHENZHEN SMOORE TECHNOLOGY LIMITED, Shenzhen (CN)

(72) Inventors: Hongming ZHOU, Shenzhen (CN); Wangsheng LIU, Shenzhen (CN); Feng CHEN, Shenzhen (CN); Xiaofeng LIAO, Shenzhen (CN)

(21) Appl. No.: 17/716,480

(22) Filed: Apr. 8, 2022

Related U.S. Application Data
(63) Continuation of application No. PCT/CN2021/106595, filed on Jul. 15, 2021.

(30) Foreign Application Priority Data
Aug. 11, 2020 (CN) 202010803551.7

(51) Int. Cl. A24F 40/44; A24F 40/46; A24F 40/70; A24F 40/10; C04B 41/00; C04B 41/45; C04B 41/51; C04B 41/88; C04B 35/64; C04B 35/632; C04B 38/06; H05B 3/46

(52) U.S. Cl. CPC A24F 40/44; H05B 2203/013; A24F 40/70; A24F 40/10; C04B 41/009; C04B 41/4578; C04B 41/5111; C04B 41/88; C04B 35/64; C04B 35/632; C04B 38/06; H05B 3/46; C04B 2235/6028; C04B 2235/656; H05B 2203/017; A24F 40/46

(57) ABSTRACT

A vaporization core, a method of manufacturing the same, and an electronic vaporization device comprising the same are disclosed. The vaporization core includes a tubular porous substrate for forming a vaporization cavity and configured to guide liquid outside the tubular porous substrate into the vaporization cavity and a heating element disposed on an inner wall of the tubular porous substrate and configured to heat and vaporize the liquid guided into the vaporization cavity.

### CROSS-REFERENCE TO RELATED APPLICATIONS

This application is a continuation of International Application No. PCT/CN2021/106595, filed Jul. 15, 2021, which claims the benefit of priority to Chinese Application No. CN202010803551.7, filed Aug. 11, 2020. All of the disclosures of the afore-mentioned patent applications are hereby incorporated by references in their entireties

### TECHNICAL FIELD

This application relates to the field of electronic vaporizer technologies, and in particular, to an electronic vaporization device, a vaporization core, and a method for manufacturing a vaporization core.

### BACKGROUND

Currently, most ceramic vaporization cores in electronic vaporization devices adopt a structure configuration of integrated liquid guiding and heating, where a heating element generally includes a heating wire and a heating film. A ceramic vaporization core product of a heating wire type can achieve effects of a short air passage, a simple structure, and high vaporization efficiency. However, most heating wires of the product are located inside a ceramic substrate, and only few heating wires are partially exposed or not exposed at all, which greatly reduces thermal efficiency of the product. A ceramic vaporization core product of a heating film type can achieve effects of surface vaporization and high thermal efficiency. However, an air passage of the product generally has turns and is relatively long, which greatly reduces a hot feeling of a user when smoking aerosols and results in low vapor generating efficiency. However, ceramic vaporization core products generally cannot have both of the advantages, and as a result, cannot completely meet users' requirements on content and taste of aerosols. On the other hand, many existing vaporization core products require high-temperature sintering (a sintering temperature is higher than 1100 degrees Celsius) in a protective atmosphere, and some products may be even sintered under high temperature repeatedly, resulting in a complex process and high production costs.

### SUMMARY

This application provides a method for manufacturing a vaporization core, a vaporization core, and an electronic vaporization device, to resolve the problems of a complex manufacturing process and high costs of a vaporization core in existing technologies.

To resolve the foregoing technical problems, a first technical solution of this application is to provide a method for manufacturing a vaporization core, including: fabricating a porous lamellar green compact, and fabricating a heating circuit on the porous lamellar green compact; winding the porous lamellar green compact on a mould to form an inner tube, where the heating circuit is disposed on an inner wall of the inner tube; forming an outer tube on an outer wall of the inner tube; and removing the mould, and sintering the outer tube, the inner tube, and the heating circuit.

The step of removing the mould, and sintering the outer tube, the inner tube, and the heating circuit specifically includes: resting the outer tube, the inner tube, and the heating circuit in the mould under normal pressure; removing the mould along an axial direction of the inner tube; and performing normal-pressure sintering on the outer tube, the inner tube, and the heating circuit at 700 degrees Celsius to 1000 degrees Celsius in air atmosphere.

The step of fabricating a porous lamellar green compact, and fabricating a heating circuit on the porous lamellar green compact specifically includes: manufacturing raw materials for forming the porous lamellar green compact into a first slurry; manufacturing the first slurry into the porous lamellar green compact through a casting process, where a thickness of the porous lamellar green compact is 0.075 millimeters to 0.5 millimeters; and manufacturing the heating circuit on the porous lamellar green compact through screen printing.

The step of forming an outer tube on an outer wall of the inner tube specifically includes: manufacturing raw materials for forming the outer tube into a second slurry; and injecting the second slurry into a side of the inner tube away from the heating circuit, where an inner wall of the outer tube tightly fits the outer wall of the inner tube, and a thickness of the outer tube is 0.2 millimeters to 3.0 millimeters.

The raw materials forming the porous lamellar green compact include a first powder and a first solvent; the first powder includes a ceramic powder, a first sintering additive, and a pore-forming agent; a mass percentage of the first sintering additive in the first powder is 1% to 40%, and a mass percentage of the pore-forming agent is not greater than two times of total mass of the ceramic powder and the first sintering additive. The first solvent includes one or more of a dispersant, an adhesive, a plasticizer, and a coupling agent, and a mass percentage of the adhesive is 1% to 40% of the first powder.

The raw materials forming the outer tube include a second powder and a second solvent; the second powder includes a ceramic powder, a second sintering additive, and a pore-forming agent; a mass percentage of the second sintering additive is 2% to 40% of total mass of the second power; a mass percentage of the pore-forming agent is 5% to 80% of the total mass of the second powder; the second sintering additive includes a framework-forming agent, and a mass percentage of the framework-forming agent is 5% to 150% of the total mass of the second powder.

The raw materials forming the outer tube include a second powder and a second solvent; the second powder includes a ceramic powder, a second sintering additive, and a pore-forming agent; a mass percentage of the second sintering additive is 2% to 40% of total mass of the second power; a mass percentage of the pore-forming agent is 5% to 80% of the total mass of the second powder; the second sintering additive includes an organic monomer, and a mass percentage of the organic monomer is 0.1% to 20% of the total mass of the second powder.

To resolve the foregoing technical problems, a second technical solution of this application is to provide a vaporization core, including: a tubular porous substrate, forming a vaporization cavity and configured to guide liquid outside the tubular porous substrate into the vaporization cavity; and a heating element, disposed on an inner wall of the tubular porous substrate and configured to heat and vaporize the liquid guided into the vaporization cavity.

The tubular porous substrate includes an inner tube and an outer tube, the outer tube is sleeved on the inner tube, an outer wall of the inner tube tightly fits an inner wall of the outer tube, and the vaporization cavity is formed inside the inner tube; and the heating element is disposed on an inner wall of the inner tube.

Materials of the tubular porous substrate include porous ceramics, the porous ceramics has a porosity of 30% to 80% and a pore size of 10 micrometers to 150 micrometers.

The heating element includes a heating film; and the heating film includes at least one of the following metal components: platinum, gold, silver, silver-palladium, or silver-platinum.

A wall thickness of the inner tube is 0.075 millimeters to 0.5 millimeters; and a wall thickness of the outer tube is 0.2 millimeters to 3.0 millimeters.

To resolve the foregoing technical problems, a third technical solution of this application is to provide an electronic vaporization device, including: a liquid storage cavity configured to store a vaporization medium and the vaporization core described above, where the vaporization medium in the liquid storage cavity is capable of being transmitted to the vaporization cavity through the tubular porous substrate.

Beneficial effects of this application are as follows: different from the existing technologies, this application provides a method for manufacturing a vaporization core, a vaporization core, and an electronic vaporization device. The manufacturing method includes: manufacturing a heating circuit on a prepared porous lamellar green compact; winding the porous lamellar green compact on a mould to form an inner tube, where the heating circuit is disposed on an inner wall of the inner tube; forming an outer tube on a side of the inner tube away from the heating circuit; and removing the mould, and sintering the outer tube, the inner tube, and the heating circuit. According to the method for manufacturing a vaporization core provided in this application, a heating circuit is formed on a porous lamellar green compact and an inner tube is formed through winding; an outer tube is formed on the peripheral of the inner tube; the inner tube having the heating circuit and the outer tube formed on an outer side are sintered, thereby reducing the processing difficulty of manufacturing the heating circuit on an inner wall of the inner tube, simplifying the processing of the vaporization core, and reducing manufacturing costs.

### BRIEF DESCRIPTION OF THE DRAWINGS

FIG. 1 is a schematic flowchart of an embodiment of a method for manufacturing a vaporization core according to this application;

FIG. 2(a) is a schematic structural diagram corresponding to step S11 of the method for manufacturing a vaporization core in FIG. 1;

FIG. 2(b) is a schematic structural diagram corresponding to step S12 of the method for manufacturing a vaporization core in FIG. 1;

FIG. 2(c) is a schematic structural diagram corresponding to step S13 of the method for manufacturing a vaporization core in FIG. 1;

FIG. 2(d) is a schematic structural diagram corresponding to step S14 of the method for manufacturing a vaporization core in FIG. 1;

FIG. 3 is a schematic flowchart of another embodiment of a method for manufacturing a vaporization core according to this application;

FIG. 4 is a schematic structural diagram of an embodiment of a vaporization core according to this application;

FIG. 5 is a top view of the vaporization core in FIG. 4; and

FIG. 6 is a schematic structural diagram of an embodiment of an electronic vaporization device according to this application.

### DETAILED DESCRIPTION

Technical solutions of embodiments of this application are described in detail below with reference to the accompanying drawings of this specification.

In the following description, for the purpose of illustration rather than limitation, specific details such as the specific system structure, interface, and technology are proposed for a thorough understanding of this application.

The technical solutions in the embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

In this application, the terms “first”, “second”, and “third” are used for descriptive purposes only and are not to be construed as indicating or implying relative importance or implicitly indicating the number of indicated technical features. Therefore, features defined by “first”, “second”, and “third” can explicitly or implicitly include at least one of the features. In the description of this application, “more” means at least two, such as two and three unless it is specifically defined otherwise. All directional indications (for example, up, down, left, right, front, and rear) in the embodiments of this application are only used for explaining relative position relationships, movement situations or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, method, system, product, or device that includes a series of steps or units is not limited to the listed steps or units, but further optionally includes a step or unit that is not listed, or further optionally includes another step or unit that is intrinsic to the process, method, product, or device.

Embodiment mentioned in the specification means that particular features, structures, or characteristics described with reference to the embodiment may be included in at least one embodiment of this application. The term appearing at different positions of this specification may not refer to the same embodiment or an independent or alternative embodiment that is mutually exclusive with another embodiment. A person skilled in the art explicitly or implicitly understands that the embodiments described in the specification may be combined with other embodiments.

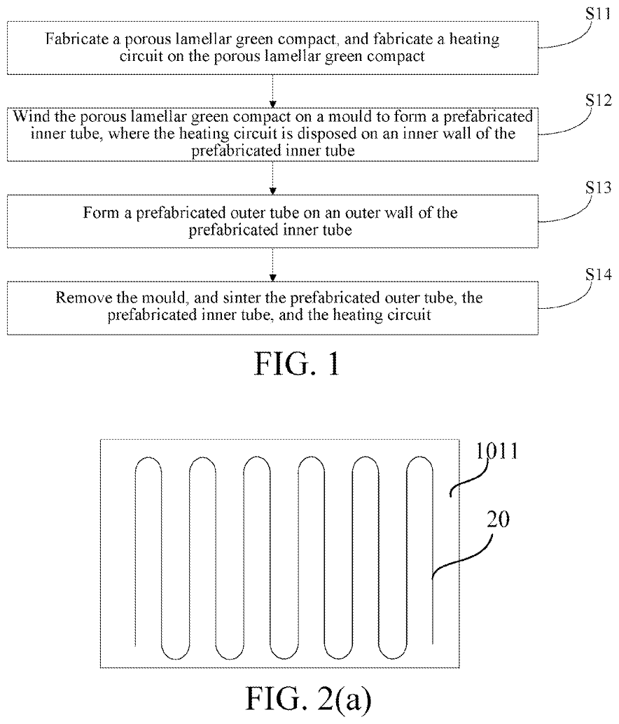

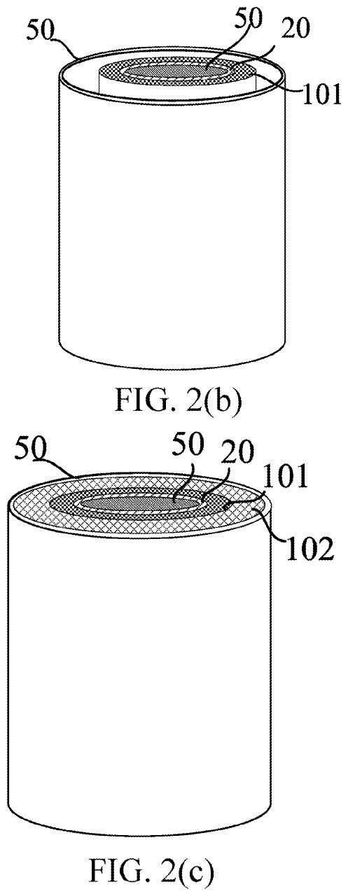

Referring to FIG. 1 and FIG. 2, FIG. 1 is a schematic flowchart of an embodiment of a method for manufacturing a vaporization core according to this application; FIG. 2(a) is a schematic structural diagram corresponding to step S11 of the method for manufacturing a vaporization core in FIG. 1; FIG. 2(b) is a schematic structural diagram corresponding to step S12 of the method for manufacturing a vaporization core in FIG. 1; FIG. 2(c) is a schematic structural diagram corresponding to step S13 of the method for manufacturing a vaporization core in FIG. 1; and FIG. 2(d) is a schematic structural diagram corresponding to step S14 of the method for manufacturing a vaporization core in FIG. 1. In this embodiment, the method for manufacturing a vaporization core 100 includes the following steps.

S11: Fabricate a porous lamellar green compact, and fabricate a heating circuit on the porous lamellar green compact.

Specifically, raw materials for forming a porous lamellar green compact 1011 are manufactured into a first slurry, and the sheet-like porous lamellar green compact 1011 is then formed through a casting process. Specifically, the casting process means placing a fluid slurry on a carrying plane, and forming a sheet with uniform thickness through scraping or rolling. The first slurry is manufactured into the porous lamellar green compact 1011 through the casting process, and a thickness of the porous lamellar green compact 1011 is 0.075 millimeters to 0.5 millimeters. A heating circuit 20 is printed on the porous lamellar green compact 1011 (referring to FIG. 2(a)). The raw materials forming the porous lamellar green compact 1011 include a first powder and a first solvent; the first powder includes a ceramic powder, a first sintering additive, and a pore-forming agent; a mass percentage of the first sintering additive in the first powder is 1% to 40%, and a mass percentage of the pore-forming agent is less than or equal to two times of total mass of the ceramic powder and the first sintering additive; the first solvent includes one or more of a dispersant, an adhesive, a plasticizer, and a coupling agent, and a mass percentage of the adhesive is 1% to 40% of the first powder.

S12: Wind the porous lamellar green compact on a mould to form an inner tube, where the heating circuit is disposed on an inner wall of the inner tube.

Specifically, the obtained porous lamellar green compact 1011 is wound on a mould 50 to form an inner tube 101 (referring to FIG. 2(c)). The mould 50 is an annular cylinder structure, and the porous lamellar green compact 1011 is wound on an inner ring of the annular mould 50, so that one side of the porous lamellar green compact 1011 on which the heating circuit 20 is printed tightly fits the inner ring of the annular mould 50. The inner ring may be a hollow structure or may be a solid structure.

S13: Form an outer tube on an outer wall of the inner tube.

Specifically, the outer tube is formed on the outer wall of the inner tube through injection moulding. Raw materials for forming the outer tube 102 are manufactured into a second slurry. The second slurry is injected into a side of the inner tube 101 away from the heating circuit 20, an inner wall of the outer tube 102 tightly fits an outer wall of the inner tube 101, and a thickness of the outer tube 102 is 0.2 millimeters to 3.0 millimeters (referring to FIG. 2(c)). The raw materials forming the outer tube 102 include a second powder and a second solvent; the second powder includes a ceramic powder, a second sintering additive, and a pore-forming agent; a mass percentage of the second sintering additive is 2% to 40% of total mass of the second power; a mass percentage of the pore-forming agent is 5% to 80% of the total mass of the second powder; the second sintering additive includes a framework-forming agent, and a mass percentage of the framework-forming agent is 5% to 150% of the total mass of the second powder. In an optional embodiment, the raw materials forming the outer tube 102 include a second powder and a second solvent; the second powder includes a ceramic powder, a second sintering additive, and a pore-forming agent; a mass percentage of the second sintering additive is 2% to 40% of total mass of the second power; a mass percentage of the pore-forming agent is 5% to 80% of the total mass of the second powder; the second sintering additive includes an organic monomer, and a mass percentage of the organic monomer is 0.1% to 20% of the total mass of the second powder.

S14: Remove the mould, and sinter the outer tube, the inner tube, and the heating circuit.

Specifically, the outer tube 102, the inner tube 101, and the heating circuit 20 in the mould 50 are rested under normal pressure; the mould 50 is removed along an axial direction of the inner tube 101 (referring to FIG. 2(d)); and an inner cavity of the inner tube 101 forms a vaporization cavity 30. Normal-pressure sintering is performed on the outer tube 102, the inner tube 101, and the heating circuit 20 at 700 degrees Celsius to 1000 degrees Celsius in air atmosphere.

According to the method for manufacturing a vaporization core provided in this embodiment, a heating circuit is formed on a porous lamellar green compact and an inner tube is formed through winding; an outer tube is formed on the peripheral of the inner tube; the inner tube having the heating circuit and the outer tube formed on an outer side are sintered, thereby reducing the processing difficulty of manufacturing the heating circuit on an inner wall of the inner tube, simplifying the processing of the vaporization core, and reducing manufacturing costs.

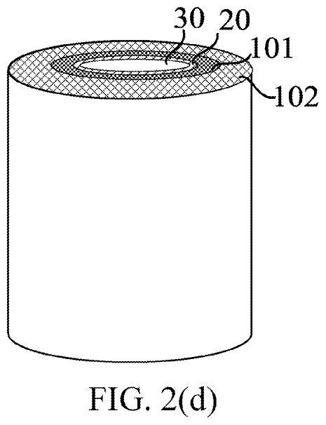

Referring to FIG. 3, FIG. 3 is a schematic flowchart of another embodiment of a method for manufacturing a vaporization core according to this application. In this embodiment, the method for manufacturing a vaporization core includes the following steps.

S21: Manufacture raw materials for forming a porous lamellar green compact into a first slurry.

Specifically, raw materials forming the porous lamellar green compact are prepared, and the prepared raw materials are mixed uniformly to manufacture a first slurry. The raw materials forming the porous lamellar green compact include a first powder and a first solvent; the first powder includes a ceramic powder, a first sintering additive, and a pore-forming agent; a mass percentage of the first sintering additive in the first powder is 1% to 40%, and a mass percentage of the pore-forming agent is not greater than two times of total mass of the ceramic powder and the first sintering additive; the first solvent includes at least one of a dispersant, an adhesive, a plasticizer, or a coupling agent, and a mass percentage of the adhesive is 1% to 40% of the first powder. Mass percentages of the first sintering additive, the pore-forming agent, and the adhesive may be determined according to a sintering shrinkage ratio of the required inner tube.

In a specific embodiment, the ceramic powder includes one or more of silicon dioxide, quartz sand, diatomite, alumina, magnesium oxide, kaolin, mullite, and cordierite; the sintering additive includes one or more of anhydrous sodium carbonate, anhydrous potassium carbonate, albite, potash feldspar, clay, bloating clay, and glass powder; and the pore-forming agent includes at least one of sawdust, cenosphere, graphite powder, amylum, flour, walnut powder, polystyrene spheres, or polymethylmethacrylate spheres. The adhesive includes one or more of polyvinyl acetate, polyvinyl acetal, ethylene-vinyl acetate copolymer resin, vinyl chloride-vinyl acetate copolymer resin, perchlorovinyl resin, polyacrylate, polyamide, and polysulfone. The framework-forming agent includes one or more of paraffin, microcrystalline paraffin, vegetable oil, polyethylene, polypropylene, atactic polypropylene, polystyrene, polymethylmethacrylate, ethylene-vinyl acetate copolymer, and ethylene-ethyl acrylate copolymer. The organic monomer includes one or more of agar, agarose, gelatin, pectin, chitosan, protein, sodium alginate, acrylamide, alkyl methacrylate, allyl methacrylate, propyl methacrylate, and methyl methacrylate.

S22: Manufacture the first slurry into the porous lamellar green compact through a casting process.

Specifically, the manufactured first slurry is manufactured into the porous lamellar green compact through a casting process, namely, a porous lamellar sheet is formed. In an optional embodiment, the manufactured first slurry may be alternatively manufactured into the porous lamellar green compact through film rolling. A thickness of the porous lamellar green compact may be 0.075 millimeters to 0.5 millimeters.

S23: Manufacture a heating circuit on the porous lamellar green compact through screen printing.

Specifically, a heating circuit is printed on a side surface of the porous lamellar green compact. In a specific embodiment, materials of the heating circuit may be silver, silver-palladium, or silver-platinum, or may be any one of gold or platinum. The materials of the heating circuit have good heat resistance, so that the heating circuit may be sintered together with the inner tube and the outer tube at 700 degrees Celsius to 1000 degrees Celsius. Preparation of the heating circuit may be alternatively implemented through any one of sputtering, evaporation, screen printing, coating, and inkjet printing, and the heating circuit may be alternatively manufactured in other manners, provided that a heating circuit meeting requirements can be manufactured.

S24: Wind the porous lamellar green compact on a mould to form an inner tube.

Specifically, the porous lamellar green compact on which the heating circuit is printed is wound on a mould to form an inner tube. The porous lamellar green compact surrounds an inner ring of the mould to form a hollow tubular structure, namely, form the inner tube. One side on which the heating circuit is printed of the porous lamellar green compact tightly fits the inner ring structure.

S25: Manufacture raw materials for forming a outer tube into a second slurry.

Specifically, the raw materials forming the outer tube are prepared, and the prepared raw materials forming the outer tube are mixed uniformly to form the second slurry according to a preset ratio; and the second slurry is injected into a side of the inner tube away from the heating circuit, an inner wall of the outer tube tightly fits an outer wall of the inner tube, and a thickness of the outer tube is 0.2 millimeters to 3.0 millimeters. The raw materials of the second slurry include a second powder and a second solvent; the second powder includes a ceramic powder, a second sintering additive, and a pore-forming agent; a mass percentage of the second sintering additive is 2% to 40% of total mass of the second power; a mass percentage of the pore-forming agent is 5% to 80% of the total mass of the second powder; the second sintering additive includes a framework-forming agent, and a mass percentage of the framework-forming agent is 5% to 150% of the total mass of the second powder. The second sintering additive further includes a surface active agent, a plasticizer, and a coupling agent. Mass percentages of the second sintering additive, the pore-forming agent, and the framework-forming agent may be determined according to a sintering shrinkage ratio of the required outer tube.

In another optional embodiment, the raw materials of the second slurry include a second powder and a second solvent; the second powder includes a ceramic powder, a second sintering additive, and a pore-forming agent; a mass percentage of the second sintering additive is 2% to 40% of total mass of the second power; a mass percentage of the pore-forming agent is 5% to 80% of the total mass of the second powder; the second sintering additive includes an organic monomer, and a mass percentage of the organic monomer is 0.1% to 20% of the total mass of the second powder. The second sintering additive further includes deionized water, a crosslinking agent, an initiating agent, a dispersant, and a PH regulator. Mass percentages of the second sintering additive, the pore-forming agent, and the organic monomer may be determined according to a sintering shrinkage ratio of the required outer tube.

In a specific embodiment, the ceramic powder includes one or more of silicon dioxide, quartz sand, diatomite, alumina, magnesium oxide, kaolin, mullite, and cordierite; the sintering additive includes one or more of anhydrous sodium carbonate, anhydrous potassium carbonate, albite, potash feldspar, clay, bloating clay, and glass powder; and the pore-forming agent includes at least one of sawdust, cenosphere, graphite powder, amylum, flour, walnut powder, polystyrene spheres, or polymethylmethacrylate spheres. The adhesive includes one or more of polyvinyl acetate, polyvinyl acetal, ethylene-vinyl acetate copolymer resin, vinyl chloride-vinyl acetate copolymer resin, perchlorovinyl resin, polyacrylate, polyamide, and polysulfone. The framework-forming agent includes one or more of paraffin, microcrystalline paraffin, vegetable oil, polyethylene, polypropylene, atactic polypropylene, polystyrene, polymethylmethacrylate, ethylene-vinyl acetate copolymer, and ethylene-ethyl acrylate copolymer. The organic monomer includes one or more of agar, agarose, gelatin, pectin, chitosan, protein, sodium alginate, acrylamide, alkyl methacrylate, allyl methacrylate, propyl methacrylate, and methyl methacrylate.

In another optional embodiment, the sintering shrinkage ratio of the inner tube is close to the sintering shrinkage ratio of the outer tube. In a preferred embodiment, the sintering shrinkage ratio of the inner tube is the same as the sintering shrinkage ratio of the outer tube.

S26: Inject the second slurry into a side of the inner tube away from the heating circuit to form the outer tube.

Specifically, the second slurry is injected into a side of the inner tube away from the heating circuit to form the outer tube, the inner wall of the outer tube tightly fits the outer wall of the inner tube, and the thickness of the outer tube is 0.2 millimeters to 3.0 millimeters.

S27: Remove the mould, and sintering the outer tube, the inner tube, and the heating circuit.

Specifically, the outer tube, the inner tube, and the heating circuit in the mould are rested under normal pressure; the mould is removed along an axial direction of the inner tube; and normal-pressure sintering is performed on the outer tube, the inner tube, and the heating circuit at 700 degrees Celsius to 1000 degrees Celsius in air atmosphere. In a specific embodiment, after the operation of forming the outer tube by using the second slurry is completed, the mould is removed after the entire structure is rested under normal pressure for 15 minutes; the structure is reserved, and normal-pressure sintering is performed on the outer tube, the inner tube, and the heating circuit at a sintering temperature of 700 degrees Celsius to 1000 degrees Celsius in the air. After the sintering is completed, two electrodes of the heating element are led out from an end of the vaporization cavity away from a communication air outlet channel, for the heating element to be connected to a power supply through the electrodes.

The method for manufacturing a vaporization core provided in this embodiment includes: printing a heating circuit on a prepared porous lamellar green compact; winding the porous lamellar green compact on a mould to form an inner tube, to cause the heating circuit to be close to the mould; forming an outer tube on a side of the inner tube away from the heating circuit through injection moulding; and removing the mould, and performing normal-pressure sintering on the outer tube, the inner tube, and the heating circuit to obtain a vaporization core. A heating circuit is formed on a porous lamellar green compact and an inner tube is formed through winding; an outer tube is formed on the peripheral of the inner tube; the inner tube having the heating circuit and the outer tube formed on an outer side are sintered, thereby reducing the processing difficulty of manufacturing the heating circuit on an inner wall of the inner tube, simplifying the processing of the vaporization core, and reducing manufacturing costs.

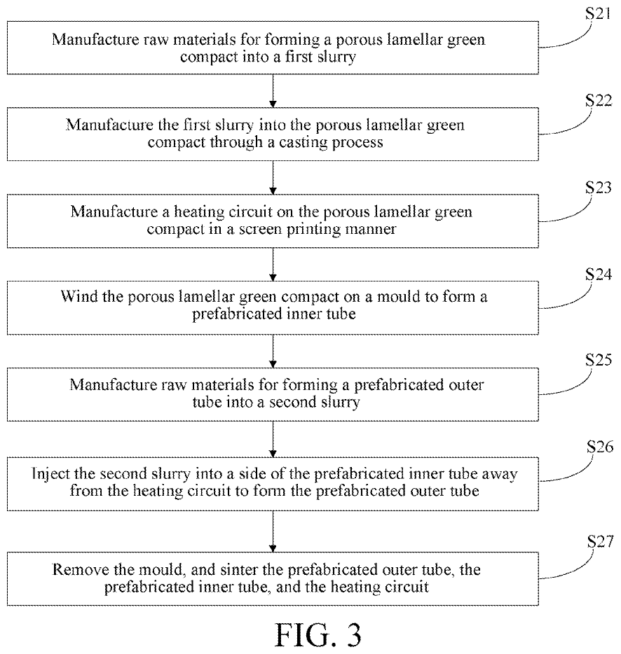

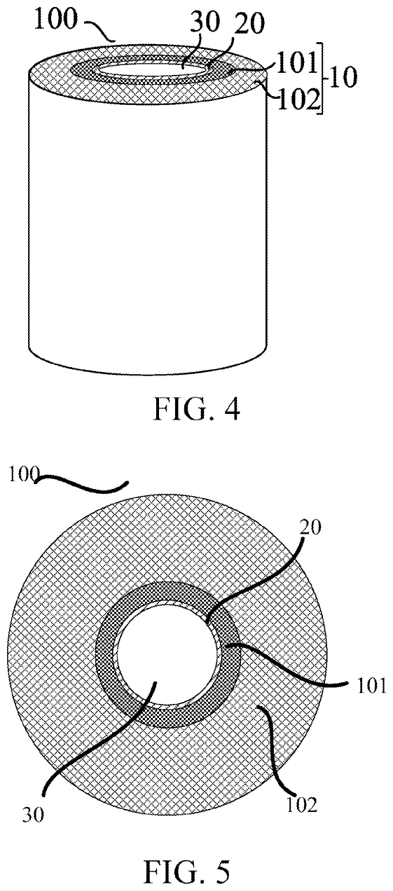

Referring to FIG. 4 and FIG. 5, FIG. 4 is a schematic structural diagram of an embodiment of a vaporization core according to this application. FIG. 5 is a top view of the vaporization core in FIG. 4. In this embodiment, a vaporization core 100 is provided, and the vaporization core 100 includes a tubular porous substrate 10 and a heating element 20.

The tubular porous substrate 10 forms a vaporization cavity 30, and the tubular porous substrate 10 is configured to guide liquid outside the tubular porous substrate 10 into the vaporization cavity 30. The vaporization cavity 30 is in communication with an air outlet channel of a nozzle. In an optional embodiment, the tubular porous substrate 10 includes an inner tube 101 and an outer tube 102, the outer tube 102 is sleeved on the inner tube 101, an outer wall of the inner tube 101 tightly fits an inner wall of the outer tube 102, and the vaporization cavity 30 is formed inside the inner tube 101; and the heating element 20 is disposed on an inner wall of the inner tube 101. A wall thickness of the inner tube 101 is 0.075 millimeters to 0.5 millimeters. A wall thickness of the inner tube 102 is 0.2 millimeters to 3.0 millimeters. In a specific embodiment, materials of the tubular porous substrate 10 include porous ceramics, and the porous ceramics has a porosity of 30% to 80% and a pore size of 10 micrometers to 150 micrometers. In an optional embodiment, a pore size on the inner tube 101 is less than a pore size on the outer tube 102, so that a flow speed of liquid guided into the vaporization cavity 30 may be further adjusted, to prevent an excessively high speed of the guided liquid from affecting a vaporization effect. In a specific embodiment, the inner tube 101 and the outer tube 102 have similar ceramic components, and similar shrinkage ratios of the materials, so that the inner tube and the outer tube can match with each other, and the inner tube 101 and the outer tube 102 can be attached to each other after sintering to form an integral structure.

The heating element 20 is disposed on an inner wall of the tubular porous substrate 10, and the heating element 20 is configured to heat and vaporize the liquid guided into the vaporization cavity 30. In a specific embodiment, the heating element 20 includes a heating circuit arranged in an S shape, or a heating circuit arranged in a ring shape. The heating element 20 includes a heating film; and the heating film includes at least one of the following metal components: platinum, gold, silver, silver-palladium, or silver-platinum. The heating element 20 further includes electrodes, and the electrodes are connected to two ends of the heating circuit. The electrodes are introduced out from one end of the vaporization cavity 30 away from a communication air outlet channel. The liquid in this embodiment is a vaporization medium (oil, leaf, flower, or grass/liquid, flower, oil, or paste).

According to the vaporization core provided in this embodiment, the vaporization medium in a liquid storage cavity is guided into the vaporization cavity through the disposed tubular porous substrate, the vaporization medium in the vaporization cavity is then heated by the heating element, and the vaporization medium directly enters the air outlet channel from the vaporization cavity after being vaporized and then directly enters a mouth of a user. The entire air passage is short, the structure is simple, and the vaporization efficiency is high. As a result, users' requirements on content and taste of aerosols can be met.

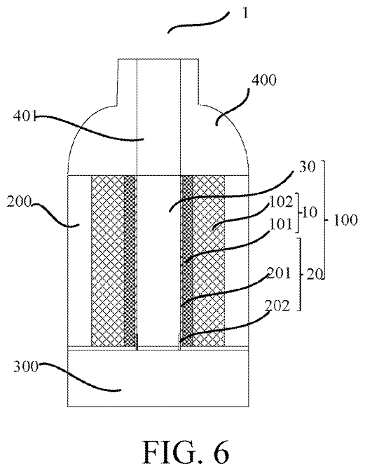

Referring to FIG. 6, FIG. 6 is a schematic structural diagram of an embodiment of an electronic vaporization device according to this application. This embodiment provides an electronic vaporization device 1, and the electronic vaporization device 1 includes a liquid storage cavity 200 configured to store a vaporization medium, a vaporization core 100, and a nozzle 400, where the vaporization medium in the liquid storage cavity 200 is capable of being transmitted to a vaporization cavity 30 through a tubular porous substrate 10. The structure of the vaporization core 100 is as described in the foregoing embodiment. In an optional embodiment, the vaporization cavity 30 of the vaporization core 100 is in direct communication with an air outlet channel 401 of the nozzle 400.

In another specific embodiment, the vaporization core 100 includes a tubular porous substrate 10 and a heating element 20. The tubular porous substrate 10 includes an inner tube 101 and an outer tube 102, the outer tube 102 is sleeved on the inner tube 101, and the inner tube 101 and the outer tube 102 may be disposed integrally. The heating element 20 includes a heating circuit 201 and electrodes 202, and the electrodes 202 are electrically connected to two ends of the heating circuit 201. The heating circuit 201 is disposed on an inner wall of the inner tube 101, and the electrodes 202 are disposed inside the vaporization cavity 30. The liquid storage cavity 200 is disposed on the periphery of the vaporization core 100, the liquid storage cavity 200 is configured to store the vaporization medium, and the vaporization medium in the liquid storage cavity 200 is guided into the vaporization cavity 30 of the vaporization core 100 through the tubular porous substrate 10.

The electronic vaporization device 1 further includes a power supply 300. The power supply 300 may be disposed at the bottom of the vaporization core 100, and the power supply 300 is electrically connected to the electrodes 202; and the nozzle 400 is disposed at the top of the vaporization core 100, the nozzle 400 includes an air outlet channel 401, and the air outlet channel 401 is in communication with the vaporization cavity 30 of the vaporization core 100.

When using the electronic vaporization device 1, a user turns on the power supply 300; the heating circuit 201 vaporizes the vaporization medium in the vaporization cavity 30, and the vaporized vaporization medium enters the mouth of the user from the vaporization cavity 30 through the air outlet channel 401 of the nozzle 400. The entire air passage is short, so that the user's requirements on content and taste of aerosols can be met.

According to the electronic vaporization device provided in this embodiment, the vaporization medium in a liquid storage cavity is guided into the vaporization cavity through the tubular porous substrate, the vaporization medium in the vaporization cavity is then heated by the heating element, and the vaporization medium directly enters the air outlet channel of the nozzle from the vaporization cavity after being vaporized and then directly enters a mouth of a user. The entire air passage is short, the structure is simple, and the vaporization efficiency is high, so that users' requirements on content and taste of aerosols can be met.

The foregoing descriptions are merely embodiments of this application, and the protection scope of this application is not limited thereto. All equivalent structure or process changes made according to the content of this specification and accompanying drawings in this application or by directly or indirectly applying this application in other related technical fields shall fall within the protection scope of this application.

What is claimed is:

1. A method for manufacturing a vaporization core, comprising:
providing a porous lamellar green compact and a heating circuit on the porous lamellar green compact;
forming an inner tube from the porous lamellar green compact, wherein the heating circuit is disposed on an inner wall of the inner tube;
forming an outer tube on an outer wall of the inner tube; and
sintering the outer tube, the inner tube, and the heating circuit.

2. The method for manufacturing a vaporization core according to claim 1, wherein the step of forming the inner tube from the porous lamellar green compact comprises winding the porous lamellar green compact on a mould.

3. The method for manufacturing a vaporization core according to claim 2, further comprising removing the mould from the inner tube.

4. The method for manufacturing a vaporization core according to claim 3, wherein the steps of removing the mould and sintering the outer tube, the inner tube, and the heating circuit comprises:
resting the outer tube, the inner tube, and the heating circuit in the mould under a normal pressure;
removing the mould along an axial direction of the inner tube; and
sintering the outer tube, the inner tube, and the heating circuit under the normal pressure and at 700 degrees Celsius to 1000 degrees Celsius in air atmosphere.

5. The method for manufacturing a vaporization core according to claim 3, wherein the step of providing a porous lamellar green compact and a heating circuit on the porous lamellar green compact comprises:
manufacturing raw materials for forming the porous lamellar green compact into a first slurry;
manufacturing the first slurry into the porous lamellar green compact through a casting process, wherein a thickness of the porous lamellar green compact is 0.075 millimeters to 0.5 millimeters; and
manufacturing the heating circuit on the porous lamellar green compact through screen printing.

6. The method for manufacturing a vaporization core according to claim 3, wherein the step of forming an outer tube on an outer wall of the inner tube comprises:
manufacturing raw materials for forming the outer tube into a second slurry; and
injecting the second slurry into a side of the inner tube away from the heating circuit, wherein an inner wall of the outer tube tightly fits the outer wall of the inner tube, and a thickness of the outer tube is 0.2 millimeters to 3.0 millimeters.

7. The method for manufacturing a vaporization core according to claim 5, wherein:
the raw materials forming the porous lamellar green compact comprise a first powder and a first solvent,
the first powder comprises a ceramic powder, a first sintering additive, and a pore-forming agent,
a mass percentage of the first sintering additive in the first powder is 1% to 40%, and
a mass percentage of the pore-forming agent is not greater than two times of total mass percentage of the ceramic powder and the first sintering additive,
the first solvent comprises one or more of a dispersant, an adhesive, a plasticizer, and a coupling agent, and
a mass percentage of the adhesive in the first solvent is 1% to 40%.

8. The method for manufacturing a vaporization core according to claim 6, wherein:
the raw materials forming the outer tube comprise a second powder and a second solvent,
the second powder comprises a ceramic powder, a second sintering additive, and a pore-forming agent,
a mass percentage of the second sintering additive is 2% to 40% of total mass of the second power,
a mass percentage of the pore-forming agent is 5% to 80% of the total mass of the second powder,
the second sintering additive comprises a framework-forming agent, and
a mass percentage of the framework-forming agent is 5% to 150% of the total mass of the second powder.

9. The method for manufacturing a vaporization core according to claim 6, wherein:
the raw materials forming the outer tube comprise a second powder and a second solvent,
the second powder comprises a ceramic powder, a second sintering additive, and a pore-forming agent,
a mass percentage of the second sintering additive is 2% to 40% of total mass of the second power,
a mass percentage of the pore-forming agent is 5% to 80% of the total mass of the second powder,
the second sintering additive comprises an organic monomer, and
a mass percentage of the organic monomer is 0.1% to 20% of the total mass of the second powder.

10. A vaporization core, comprising:
a tubular porous substrate, forming a vaporization cavity and configured to guide liquid outside the tubular porous substrate into the vaporization cavity; and
a heating element, disposed on an inner wall of the tubular porous substrate and configured to heat and vaporize the liquid guided into the vaporization cavity.

11. The vaporization core according to claim 10, wherein:
the tubular porous substrate comprises an inner tube and an outer tube,
the outer tube is sleeved on the inner tube,
an outer wall of the inner tube tightly fits an inner wall of the outer tube,
the vaporization cavity is formed inside the inner tube, and
the heating element is disposed on an inner wall of the inner tube.

12. The vaporization core according to claim 10, wherein materials of the tubular porous substrate comprise porous ceramics, and the porous ceramics has a porosity of 30% to 80% and a pore size of 10 micrometers to 150 micrometers.

13. The vaporization core according to claim 10, wherein the heating element comprises a heating film; and
the heating film comprises at least one of platinum, gold, silver, silver-palladium, or silver-platinum.

14. The vaporization core according to claim 11, wherein a wall thickness of the inner tube is 0.075 millimeters to 0.5 millimeters, and a wall thickness of the outer tube is 0.2 millimeters to 3.0 millimeters.

15. An electronic vaporization device, comprising:
a liquid storage cavity configured to store a vaporization medium; and
a vaporization core including:
a tubular porous substrate having a vaporization cavity and configured to guide the vaporization medium from the liquid storage cavity into the vaporization cavity; and
a heating element disposed on an inner wall of the tubular porous substrate and configured to heat and vaporize the vaporization medium guided into the vaporization cavity.

16. The electronic vaporization device according to claim 15, wherein:
the tubular porous substrate comprises an inner tube and an outer tube,
the outer tube is sleeved on the inner tube,
an outer wall of the inner tube tightly fits an inner wall of the outer tube,
the vaporization cavity is formed inside the inner tube, and
the heating element is disposed on an inner wall of the inner tube.

17. The electronic vaporization device according to claim 15, wherein materials of the tubular porous substrate comprise porous ceramics, and the porous ceramics has a porosity of 30% to 80% and a pore size of 10 micrometers to 150 micrometers.

18. The electronic vaporization device according to claim 15, wherein the heating element comprises a heating film; and
the heating film comprises at least one of platinum, gold, silver, silver-palladium, or silver-platinum.

19. The electronic vaporization device according to claim 16, wherein a wall thickness of the inner tube is 0.075 millimeters to 0.5 millimeters, and a wall thickness of the outer tube is 0.2 millimeters to 3.0 millimeters.

20. The electronic vaporization device according to claim 15, wherein the vaporization cavity is in communication with an air outlet channel of a nozzle.
